(19) United States
(12) Patent Application Publication
(10) Pub. No.: US 2008/0305922 A1
(43) Pub. Date: Dec. 11, 2008

(54) HYBRID DRIVE SYSTEM FOR A VEHICLE AND METHOD OF OPERATING THE HYBRID DRIVE SYSTEM

(75) Inventor: Lars HOFFMANN, Bralanda (SE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/132,349

(22) Filed: Jun. 3, 2008

(30) Foreign Application Priority Data
Jun. 5, 2007 (GB) 0710782.4

(51) Int. Cl. B60K 6/22; B60L 15/00

(52) U.S. Cl. 477/3; 701/22; 903/915; 903/945

(57) ABSTRACT

A hybrid drive system is provided for a vehicle. The hybrid drive system includes, but is not limited to a traction battery, an internal combustion engine and an electric drive. The internal combustion engine and the electric drive provide propulsion drives and are configured to be operatively and selectively coupled to a transmission. The internal combustion engine includes, but is not limited to a heater for pre-heating a selected portion of the internal combustion engine. The traction battery is coupled to the heater and configured so as to be able to provide electric power to the heater whilst the propulsion drives are switched off.

### CROSS-REFERENCE TO RELATED APPLICATION

This application claims priority to Great Britain Patent Application No. 0710782.4, filed Jun. 5, 2007, which is incorporated herein by reference in its entirety.

### TECHNICAL FIELD

The present invention relates to a hybrid drive system for a vehicle and to methods of operating such a hybrid drive system.

### BACKGROUND

Hybrid drive vehicles have been developed in order to reduce the exhaust emissions of the vehicle. The hybrid drive system of a vehicle may include an internal combustion engine and an electric motor, each providing a propulsion drive for the vehicle. Hybrid drive systems in which the electric motor and the internal combustion engine are interconnected in various arrangements have been developed. For example, the electric motor and the internal combustion engine may be arranged in series or in parallel with one another. The hybrid drive system may be operated in various modes in which the electric drive and the internal combustion engine are operated either singly or simultaneously. The electric drive may also operate as a generator to charge the battery.

The internal combustion engine may be configured to run on diesel or petrol. In order to reduce further the emissions of the vehicle, internal combustion engines have been developed which run on biofuels. Such biofuels may comprise a mixture of diesel or petrol and ethanol, for example. Internal combustion engines have also been developed which are able to run on 100% ethanol.

However, internal combustion engines produce increased exhaust emissions upon a cold start which it is also desired to decrease. A further problem associated with internal combustion engines running on fuel comprising ethanol, and in particular as the percentage of ethanol in the fuel is increased to 85% or even 100%, is that the internal combustion engine cannot be started at low temperatures, for example below about −10° C. (about 14 degree Fahrenheit).

Therefore, it is desirable to provide a hybrid drive system which can be reliably started in cold weather while producing lower emissions. In addition, other desirable features and characteristics will become apparent from the subsequent summary and detailed description and the appended claims, taken in conjunction with the accompanying drawings and this background.

### SUMMARY

According to an embodiment of the invention, a hybrid drive system for a vehicle comprises a traction battery, an internal combustion engine and an electric drive. The internal combustion engine and the electric drive provide propulsion drives and are configured to be operatively and selectively coupled to a transmission of a vehicle. The internal combustion engine comprises heating means for preheating a selected portion of the internal combustion engine. The traction battery is coupled to the heating means and is configured so as to be able to provide electric power to the heating means whilst the propulsion drives are switched off.

The preferred hybrid drive system of an embodiment of the invention is configured so that the traction battery may be used to preheat the internal combustion engine of the hybrid drive system whilst internal combustion engine and the electric drive are switched off. If the temperature of the internal combustion engine is below a predetermined minimum threshold temperature, one or more selected portions of the internal combustion engine may be preheated by electric power delivered by the traction battery thus raising the temperature of the selected portion of the internal combustion engine and enabling it to be started.

Even if the internal combustion engine is at or above this predetermined minimum threshold temperature, it may still be preheated by electric power delivered by the traction battery, so as to raise the temperature towards or to an optimum start temperature in order to reduce exhaust emissions when the engine is started.

The arrangement has the further advantage that due to the supply of electric power to the heating means from the traction battery, the traction battery is also preheated, thus improving the efficiency of the battery when it is later coupled to the electric drive.

The teachings herein, therefore, can provide a hybrid drive system in which both the internal combustion engine and the traction battery may be preheated to improve efficiency and lower the overall emissions of the hybrid drive system upon a cold start. This can be achieved without requiring an external energy supply such as an electric power supply to provide the preheating since the onboard traction battery is used to supply the electric power to the heating means positioned within the internal combustion engine. Therefore, a cold start can be achieved and emissions can be reduced in situations where the vehicle does not have access to an external electricity supply.

The heating means may be arranged in one or more positions in the engine. In an embodiment, the heating means is arranged so as to be able to preheat one or more cylinder heads of the internal combustion engine. The heating means may be arranged within an engine block or within one or more cylinder heads of the internal combustion engine. The heating means may also the arranged within one or more pistons of the internal combustion engine. These arrangements provide a preheating of the cylinder head and/or pistons in order that the fuel is able to vaporise from the internal surface of the combustion chamber, thus enabling the engine to start in cold weather and reducing emissions from the internal combustion engine.

However, the heating means may also be advantageously arranged at other sites of an internal combustion engine. In further embodiments, the heating means may be arranged so as to be capable of preheating one or more of a cooling system, a fuel line, one or more injection valves, air in an air intake and connecting intake valves of the internal combustion engine.

The heating means may be provided by one or more resistance heaters. If several portions of the internal combustion engine are to be capable of being preheated, each portion may be provided with a resistance heater which can be independently controlled. Therefore, different portions and the number of different portions of internal combustion engine may be preheated depending on the difference in the actual temperature of the internal combustion engine and the predetermined minimum threshold temperature which is to be reached.

In very cold weather, −40° C. (−40 degree Fahrenheit) for example, all of the resistance heaters could be activated to preheat the internal combustion engine, whereas if the actual temperature of the internal combustion engine is only slightly below the optimum start temperature, only the cylinder heads could be preheated, for example.

The hybrid drive system may include an electric drive which is operable as a motor as well as a generator in order to take advantage of regenerative braking of the vehicle and charging of the traction battery by the internal combustion engine.

The traction battery may be a lithium ion battery. A lithium ion battery has the advantage that it provides a high cell voltage and has a high energy density. Lithium ion batteries, however, operate less efficiently and are able to deliver less power at temperatures of −5° C. (23 degree Fahrenheit) or less. The efficiency of the traction battery is improved in the hybrid drive system taught herein, since the traction battery is preheated as a result of the power delivered to preheat the internal combustion engine.

The internal combustion engine may be designed to run on fuels comprising alcohol, in particular a mixture of petrol and ethanol. In further embodiments, the fuel is petrol comprising 85% ethanol, commonly designated as E85, and 100% ethanol.

In the hybrid drive system according to one of the embodiments previously described, the propulsion drives, that is the internal combustion engine and the electric drive, may be configured to provide a parallel hybrid drive system, a compound hybrid drive system or a series hybrid drive system.

An embodiment of the invention also encompasses methods of operating a hybrid drive system for a vehicle. The hybrid drive system comprises a traction battery, a internal combustion engine and an electric drive. The internal combustion engine and the electric drive provide propulsion drives and are configured to be operatively and selectively coupled to a transmission of the vehicle. The internal combustion engine comprises heating means for preheating a selected portion of the internal combustion engine and the traction battery is coupled to the heating means. The method comprises, in response to a first condition, supplying electric power from the traction battery to be heating means before starting the propulsion drives of the vehicle.

The electric power, therefore, can be supplied from the traction battery to the heating means whilst the propulsion drives are switched off. The internal combustion engine as well as the traction battery are, therefore, pre-heated to improve the efficiency of the traction battery and to reduce the emissions of the internal combustion engine when one or more of the propulsion drives is started.

In an embodiment, the electric power is supplied to the heating means from the traction battery before one or both of the propulsion drives are coupled to the transmission. The electric power may still be supplied from the traction battery to the heating means after one or more of the propulsion drives has been started but before it is coupled to the transmission. Thus the internal combustion engine and/or the traction battery can reach an optimum temperature before the vehicle starts moving.

The electric power may be supplied from the traction battery to the heating means in response to various conditions.

In an embodiment, a temperature indicative of the temperature of the internal combustion engine is measured. If this temperature is below a predetermined minimum threshold value, electric power is supplied from the traction battery to the heating means. Therefore, preheating is only carried out if the internal combustion engine has a temperature below the predetermined minimum threshold value. Therefore, on warm days, when the internal combustion engine is above the minimum threshold value or if the internal combustion engine has only been switched off for a relatively short time and has only cooled slightly, electric power is not supplied to the heating means since preheating of the internal combustion engine is not required.

Alternatively, or in addition to the above-described methods, a temperature indicative of the environmental temperature is measured and, if this temperature is below a predetermined minimum threshold value, electric power is supplied from the traction battery to the heating means.

Vehicles typically include temperature sensors which sense the temperature of the internal combustion engine and the environmental temperature, so additional temperature sensors specifically for operating the hybrid drive system are not necessarily required. The temperature sensors used by other systems of the vehicle may be used in order to control the hybrid drive system according to the teachings herein.

The electric power may be supplied for a predetermined time interval in order to preheat the selected portion of the internal combustion engine. This time interval may be calculated based on a thermal model of the internal combustion engine and stored as a fixed predetermined time interval in a memory of a control unit.

The time interval may be calculated in dependence upon the difference between the measured temperature of the internal combustion engine and/or the measured environmental temperature and a predetermined minimum threshold temperature. This calculation may also use a thermal model of the internal combustion engine. A table of fixed predetermined time intervals calculated from a series of temperature differences may be stored in a control unit and applied to the heating means depending on the temperature measured. It is also possible to calculate the time interval each time that the actual temperature of the internal combustion engine and/or the environmental temperature is measured.

In an embodiment, a temperature indicative of the temperature of the internal combustion engine is monitored during the preheating of the internal combustion engine. The electric power is supplied until the monitored temperature is above a predetermined starting threshold temperature. This embodiment uses real time data collected from the temperature sensors of the vehicle to control the preheating of the internal combustion engine. Additionally, the preheating of the traction battery, which occurs as a result of the traction battery supplying electric power to the heating means of the internal combustion engine, may be controlled based on real time data collected from the temperature sensors.

In further embodiments, the electric power may be supplied to the heating means upon the condition that the doors of the vehicle are opened. Therefore, the internal combustion engine and the traction battery can be preheated while the driver and passengers get into the vehicle.

In a further embodiment, the electric power is supplied to the heating means from the traction battery upon the doors of the vehicle being opened by a remote control device.

In further embodiments, the electric power is supplied to the heating means from the traction battery upon an instruction from a remote device. This remote device may be provided by a further option of the remote control door opening device. This embodiment enables the user to activate the preheating of the internal combustion engine before opening the doors of the vehicle. For example, in very cold weather, −40° C. (−40 degree Fahrenheit) for example, the time interval during which preheating is required may be sufficiently long that a start of the vehicle may not be possible as soon as the driver gets into the vehicle after opening the doors. In very cold weather, the driver could, therefore, activate preheating and then a few minutes later open the doors to get into the vehicle.

### BRIEF DESCRIPTION OF THE DRAWINGS

The present invention will hereinafter be described in conjunction with the following drawing figures, wherein like numerals denote like elements, and

FIG. 1 illustrates a series a hybrid drive system according to a first embodiment;

FIG. 2 illustrates a parallel hybrid drive system according to a second embodiment; and

FIG. 3 illustrates a portion of an internal combustion engine comprising heating means coupled to the traction battery.

### DETAILED DESCRIPTION

The following detailed description is merely exemplary in nature and is not intended to limit the invention or the application and uses of the invention. Furthermore, there is no intention to be bound by any theory presented in the preceding summary and background or the following detailed description.

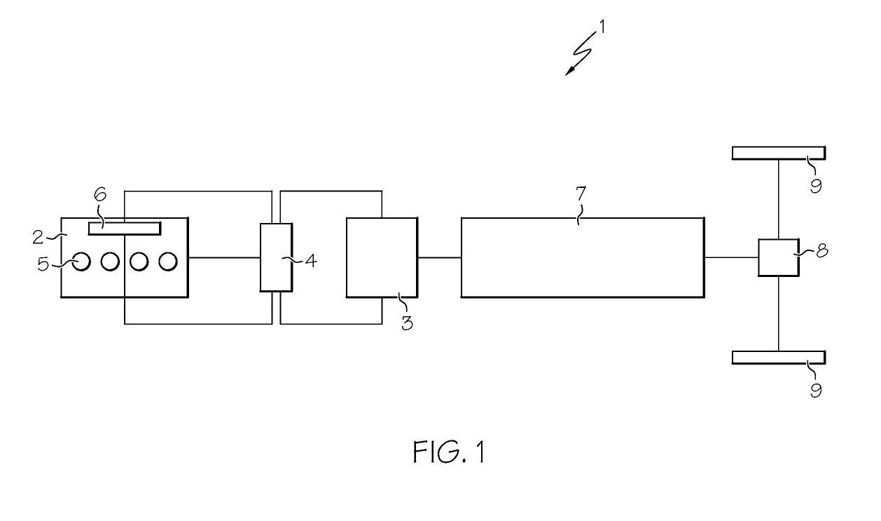

FIG. 1 schematically illustrates a system diagram of a hybrid drive system 1 for a vehicle which comprises an internal combustion engine 2, an electric drive 3 in the form of an electric motor and a traction battery 4. The internal combustion engine 2 comprises cylinders 5 and is adapted to run on a fuel comprising petrol and 85% ethanol, commonly designated as E85. The internal combustion engine 2 has an arrangement known to those skilled in the art. The electric drive 3 and internal combustion engine 2 are coupled to a transmission 7, axle 8 and wheels 9 of the vehicle. The internal combustion engine 2 and electric drive 3 are interconnected in series in the embodiment illustrated in FIG. 1.

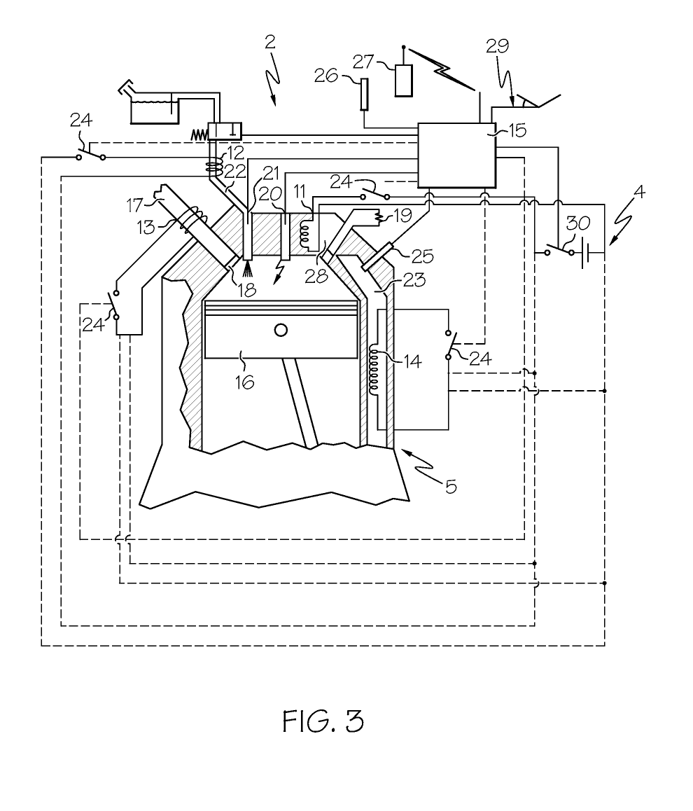

The internal combustion engine 2 also comprises heating means 6 arranged so as to be capable of pre-heating the cylinder heads 28 of the cylinders 5. The heating means 6 comprises one or more resistive heaters. Various embodiments of the arrangement of the heating means 6 with respect to the cylinders 5 are illustrated in FIG. 3.

The traction battery 4 is in the preferred embodiment a lithium ion battery which is coupled to the electric drive 3 and which is also coupled to the heating means 6 of the internal combustion engine 2. The traction battery 4 is coupled to the heating means 6 so as to be able to supply electric power to the heating means 6 whilst the electric drive 3 and internal combustion engine 2 are switched off. The traction battery 4 can, therefore, pre-heat the internal combustion engine 2 before a cold start of the vehicle in which the hybrid drive system 1 is included. The internal combustion engine 2 can, therefore, be pre-heated using the onboard electric power supply of the traction battery 4 so that an additional external power supply is not required.

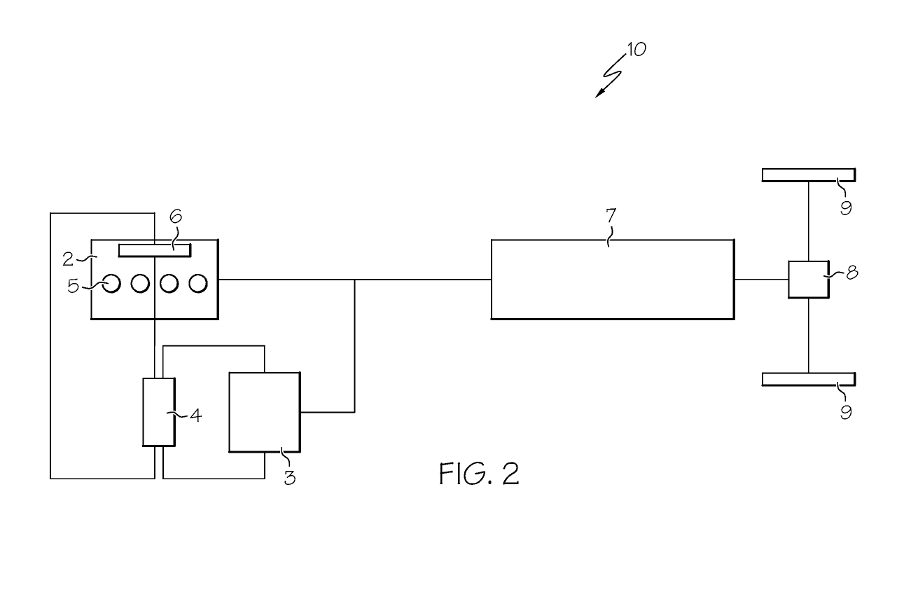

FIG. 2 illustrates a hybrid drive system 10 according to a second embodiment of the invention. Parts of the hybrid drive system 10 which are the same as those of the first embodiment illustrated in FIG. 1 are indicated by the same reference numerals. The hybrid drive system 10 comprises an internal combustion engine 2 with cylinders 5, a traction battery 4 and the electric drive 3. In the second embodiment of the invention the internal combustion engine 2 and electric drive 3 are interconnected in parallel. The internal combustion engine 2 and electric drive 3 may be selectively operatively coupled to the transmission 7 of the vehicle.

The internal combustion engine 2 also comprises heating means 6 arranged so as to be capable of preheating a selected portion of the internal combustion engine 2. The traction battery 4 is coupled to the heating means 6 so as to be able to supply electric power to the heating means 6 whilst the internal combustion engine 2 and the electric drive 3 are not operating as in the first embodiment illustrated in FIG. 1.

Once one or more of the propulsion drives have been started, the hybrid drive system may be operated in any of a number of modes known to those skilled in the art.

The heating means 6 may comprise a single resistive heater or may comprise a plurality of resistive heaters which are dependently or independently operable. Various possible arrangements of the heating means are illustrated in FIG. 3.

FIG. 3 illustrates schematically a single cylinder 5 of the internal combustion engine 2 and four resistive heating elements 11, 12 13 and 14 comprising the heating means 6. Each of the resistive heating elements 11, 12, 13 and 14 is coupled to traction battery 4 and is independently controllable by a control unit 15. The resistive heating elements 11, 12, 13, 14 may be cast into the respective portion of the internal combustion engine. Alternatively, the resistive heating elements may be positioned adjacent their respective portion. For example, a resistive heating element may be wrapped around the outside of a fuel line.

The various arrangements of the resistive heating means 6 illustrated in FIG. 3 may be used in a hybrid drive system having a series configuration, a parallel configuration or a compound configuration.

A reciprocating piston 16 is positioned within the cylinder 5 which in a further embodiment, not illustrated in the Figures, may also comprise a resistive heater. Also schematically illustrated in FIG. 3 are the air intake system 17, the air intake valve 18 and the exhaust 19 of the cylinder 5, as well as spark plug 20 and fuel injection valve 21. The spark plug 20, fuel injection valve 21, air intake system 17 and exhaust system 18 may have any configuration known in the art.

A first resistive heater 11 is illustrated as being positioned within the cylinder head 28. A second resistive heater 12 is positioned around a portion of the fuel intake line 22, which enables the fuel to be preheated before it reaches the injection valve 21. A third resistive heater 13 is positioned so as to be able to pre-heat the air in the air intake system 17. A fourth electric heater 14 is positioned so as to be able to heat the cooling jacket 23 of the cylinder 5. In each case, the electric heater is coupled to a control unit 15 by a switch 24 so that the control unit 15 can selectively open and close the electric circuit from the respective resistive heater to the traction battery 4.

The hybrid drive system 1, 10 also includes a first temperature sensor 25 positioned so as to indicate the temperature of the internal combustion engine 2. In this case, the temperature sensor 25 is illustrated as measuring the temperature of the cooling system 23. Other arrangements are, however, equally possible. Control unit 15 also comprises a second temperature sensor 26 which is arranged so as to measure a temperature indicative of the environmental temperature. The first and second temperature sensors need not be dedicated to providing data for the pre-heating system. Temperature sensors provided for other purposes within the vehicle may be used.

The control unit 15 may also be operable by a remote-control device 27. The control unit 15 from which the pre-heating of the heating means 6 by the traction battery 4 is controlled need not be exclusively provided for the system. The control unit 15 may advantageously be a part of the existing management engine management system, for example. Therefore, the control unit 15 is also illustrated as being coupled to the pedals 29 of the vehicle operated by the driver.

The cylinder 5 is illustrated as a cylinder 5 of a petrol engine. However, the internal combustion engine may be designed to run on diesel fuel, a mixture of petrol and ethanol or 100% ethanol.

The traction battery 4, the resistive heaters 11, 12, 13 and 14 and control unit 15 are configured so that in response to a first condition, the traction battery 4 is able to supply electric power to one or more of the resistive heating elements 11, 12, 13, 14 by closing the traction battery switch 30 and one or more of the resistive heater switches 24 whilst the internal combustion engine 2 and the electric drive 3 are switched off.

In a first method, the hybrid drive system (1; 10) of either the first or the second embodiment illustrated in FIGS. 1 and 2, respectively, is operated as follows.

Upon the doors of the vehicle being opened by the remote-control device 27, the temperature of the internal combustion engine 2 is measured by the first temperature sensor 18. If this temperature is below a predetermined minimum threshold a temperature, for example 10° C. (50 degree Fahrenheit) for an internal combustion engine able to run on 100% ethanol as a fuel, the switch 30 is closed, coupling the traction battery to the heating means 6 and the switch 24 of the resistive heater 11 is closed by the control unit 15.

Electric power is then delivered from the traction battery 4 to the resistive heater 11. Electric power is delivered for a predetermined time interval which is calculated based on a thermal model of the internal combustion engine 2 and the difference between the measured temperature of the internal combustion engine 2 and a predetermined minimum starting temperature.

In further embodiments, one or more of the further resistive heating elements 12, 13 and 14 are activated by the control unit 15 by closing the respective switch 24 of the resistive heating circuit. Two or more portions of the internal combustion engine 2 may be preheated by the electric power delivered by the traction battery 4.

The system can operate on the basis of any one or more heating elements 11 to 15 shown in FIG. 3 or as otherwise described herein.

While at least one exemplary embodiment has been presented in the foregoing detailed description, it should be appreciated that a vast number of variations exist. It should also be appreciated that the exemplary embodiment or exemplary embodiments are only examples, and are not intended to limit scope, applicability, or configuration in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A hybrid drive system for a vehicle, comprising:
an electric drive configured to provide a first propulsion drive;
an internal combustion engine configured to provide a second propulsion drives, the internal combustion engine comprising a heater configured to pre-heat a selected portion of the internal combustion engine;
a traction battery coupled to the heater and configured to provide electric power to the heater while the first propulsion drive and second propulsion driver are switched off, and
a transmission configured to be operatively and selectively coupled to the internal combustion engine and the electric drive.

2. The hybrid drive system according to claim 1, wherein the heater is arranged so as to be capable of heating at least one cylinder head of the internal combustion engine.

3. The hybrid drive system according to claim 1, wherein the heater is arranged within an engine block of the internal combustion engine.

4. The hybrid drive system according to claim 1, wherein the heater is arranged within at least one cylinder head of the internal combustion engine.

5. The hybrid drive system according to claim 1, wherein the heater is arranged within at least one piston of the internal combustion engine.

6. The hybrid drive system according to claim 1, wherein the heater is arranged so as to be capable of pre-heating at least one cooling system of the internal combustion engine, a fuel line of the internal combustion engine, injection valves of the internal combustion engine, air in an air intake of the internal combustion engine and an air intake valve of the internal combustion engine.

7. The hybrid drive system according to claim 1, wherein the heater is provided by at least one resistance heater.

8. The hybrid drive system according to claim 1, wherein the electric drive is operable as a motor and a generator.

9. The hybrid drive system according to claim 1, wherein the traction battery is a Li-ion battery.

10. The hybrid drive system according to claim 1, wherein the internal combustion engine is designed to run on a fuel comprising alcohol.

11. The hybrid drive system according to claim 1, wherein the internal combustion engine is designed to run on a fuel comprising a mixture of petrol and alcohol.

12. The hybrid drive system according to claim 11, wherein the fuel is petrol comprising 85% ethanol.

13. The hybrid drive system according to claim 1, wherein the internal combustion engine is designed to run on a fuel comprising 100% ethanol.

14. The hybrid drive system according to claim 1, wherein the first propulsion drive and the second propulsion drives are configured to provide a parallel hybrid drive system.

15. A hybrid drive system according to claim 1, wherein the first propulsion drive and the second propulsion driver are configured to provide a compound hybrid drive system.

16. The hybrid drive system according to claim 1, wherein the first propulsion drive and the second propulsion drive configured to provide a series hybrid drive system.

17. A method of operating a hybrid drive system for a vehicle, the hybrid drive system comprising a traction battery, an internal combustion engine and an electric drive, the internal combustion engine and the electric drive providing propulsion drives, the internal combustion engine comprising a heater for pre-heating a selected portion of the internal combustion engine and the traction battery being coupled to the heater, the method comprising the steps of:
identifying a first condition;
supplying electric power from the traction battery to the heater in response to the first condition; and
starting the propulsion drives after the supplying electric power from the traction battery to the heater in response to the first condition.

19. The method according to claim 18, wherein the electric power is supplied to the heater from the traction battery before at least one of the propulsion drives are coupled to the transmission.

20. The method according to claim 18, wherein a temperature indicative of a temperature of the internal combustion engine is measured and, if this temperature is below a predetermined minimum threshold value, performing the step of supplying electric power from the traction battery to the heater.

21. The method according to claim 18, wherein a temperature indicative of an environmental temperature is measured and, if this temperature is below a predetermined minimum threshold value, performing the step of supplying electric power from the traction battery to the heater.

22. The method according to claim 19, wherein the step of supplying electric power from the traction battery to the heater is conducted for a predetermined time interval.

23. The method according to claim 22, wherein the predetermined time interval is calculated from a thermal model of the internal combustion engine.

24. The method according to claim 22, wherein a time interval is calculated in dependence upon a difference between a measured temperature of the internal combustion engine and a predetermined minimum threshold temperature.

25. The method according to claim 18, wherein the step of supplying electric power from the traction battery to the heater is conducted until a measured temperature is greater than a predetermined starting threshold temperature.

26. The method according to claim 18, wherein the step of supplying electric power from the traction battery to the heater is conducted upon detection of at least one door opening.

27. The method according to claim 18, wherein the step of supplying electric power from the traction battery to the heater is conducted upon an instruction from a remote device.
